(19) United States
(12) Patent Application Publication
(10) Pub. No.: US 2011/0145717 A1
(43) Pub. Date: Jun. 16, 2011

(54) WEB-BROWSING SYSTEM

(76) Inventor: Jin Yong Joo, Gyunggi-do (KR)

(21) Appl. No.: 12/989,149

(22) PCT Filed: Apr. 21, 2009
(86) PCT No.: PCT/KR09/02069

§ 371 Date: Jan. 19, 2011

(30) Foreign Application Priority Data
Apr. 25, 2008 (KR) 10-2008-0039012

(51) Int. Cl. G06F 3/048

(52) U.S. Cl. 715/738

(57) ABSTRACT

A web-browsing system that enables a user to surf the web efficiently. The web-browsing system which can be installed in a client's terminal comprises: a web-browser; a function window controller that includes a function window manager consisting of a contents-information DB, a layer creator and a menu controller; and a window module that has a web-browser link unit. The contents-information DB stores at least one kind of contents among text, image, video or sound source and the contents information linked to the correspondent contents.

### TECHNICAL FIELD

The present invention relates to a web browsing system, which enables a user to efficiently surf the web.

### BACKGROUND ART

Generally, Internet web browsers that have been widely utilized enable websites on the Internet to be searched and accessed, and enable web pages provided by the accessed websites to be displayed on an output window, so that a user can view the web pages. In this case, the output window includes an address bar into which the address of a website is entered, a menu bar in which functions, such as the modification, copy, and editing of a web page, are contained, etc., as well as the web page window of a HyperText Markup Language (HTML) area in which the web page is displayed.

Generally, since the output window of a web browser is provided with a single web page window, only a single web page is displayed per output window. Therefore, in order to display a plurality of web pages, a number of output windows corresponding to the number of web pages must pop up.

However, as the number of pop-up output windows increases, it is more difficult to check and utilize the contents of web pages displayed on the output windows, and there is the inconvenience of having to individually scrap and save web pages, or to register relevant websites using ‘bookmarking (the website saving menu of Internet Explorer: IE)’, in order to save and manage the information provided by a plurality of web pages. Of course, such inconveniences must be endured by the user in order to manage the desired information. However, since conventional schemes resulting in such inconveniences must save and manage the entirety of a web page including even unnecessary information in order to manage only a part of a plurality of pieces of information included in the web page, there is difficulty in smoothly utilizing information as the number of pieces of information that must be managed increases.

Further, since output windows are independent of one another, a procedure for downloading (copying) relevant data from any output window and uploading (pasting) the data to another output window must be repeatedly performed during the process of exchanging data included in two or more output windows (the action of extracting videos or images and attaching them to another web page), and if necessary, a script forming a web page must be personally edited, thus resulting in limitations when efficiently utilizing the Internet.

### DISCLOSURE

### Technical Problem

Accordingly, the present invention has been made keeping in mind the above problems, and an object of the present invention is to provide a web browsing system, which allows a user using the Internet to easily and conveniently access his or her desired website, obtain required information from the website, acquire various types of information using a minimum number of output windows while easily extracting and managing only part of a web page constituting the website, and efficiently utilize even multimedia and multi-communication.

### TECHNICAL SOLUTION

In order to accomplish the above object, the present invention provides a web browsing system, including a web browser; and a functional window module, wherein the functional window module includes functional window control means which includes a functional window manager having a content information database (DB) for storing information about one or more selected from among text, images, video and sound sources, and content information linked to relevant information, a layer creator for checking locations and sizes of a menu bar and an address bar in an existing output window that includes a web page window which is an HTML area in which a web page is displayed and that is displayed when the web browser is running, and for activating a layered functional window in the HTML area so that the layered functional window hides one or more selected from among the menu bar and the address bar and is displayed as a single output window, the functional window being configured such that a functional page for posting content information is displayed, and a menu controller for controlling interaction with the web browser to enable Internet access based on content information posted on the functional window; and web browser interaction means for mediating interaction between the menu controller and the web browser, the web browsing system being installed in a client terminal.

### ADVANTAGEOUS EFFECTS

The present invention is advantageous in that one output window is partitioned into various areas so that a functional window can be added, wherein the functional window enables the number of pop-up operations and pop-down operations of the output window to be remarkably reduced while being operated and managed independently of a web page window, and wherein the functional window enables services, such as playing videos, playing music, communication means, for example, a messenger and a Short Message Service (SMS), electronic commerce, and RDF Site Summary (RSS), to be provided using a minimum number of output windows even while a specific web page is being displayed. Further, the present invention is also advantageous in that a personal space such as the user's homepage or blog is acquired as a fixed space, thus enabling the personal space to be stably used even during web surfing, regardless of the types and contents of the pop-up output windows.

Further, there are advantages in that in the current tendency to aim at a bidirectional customized service in accordance with the tendency and preference of each Internet user and to advocate a space which attaches a great importance to ‘me’, innovative variation can occur in the use of a web browser in such a way that the use of functional windows, always exposed when web surfing is performed, becomes a main object, and the use of services provided by a web page output window becomes an auxiliary object while the functional windows are used as a ‘space only for me and a space for maximizing my convenience’.

### DESCRIPTION OF DRAWINGS

FIG. 1 is a block diagram showing the construction of a web browsing system according to the present invention;

FIG. 2 is a view showing the shapes of an existing output window and a first output window implemented by the web browsing system according to the present invention;

FIG. 3 is a block diagram showing the construction of a functional window control means according to the present invention;

FIGS. 4 and 5 are diagrams showing the shapes of second and third output windows implemented by the web browsing system according to the present invention;

FIG. 6 is a view of a screen showing the operation of the web browsing system according to the present invention;

FIGS. 7 to 10 are views showing the shapes of sixth to ninth output windows implemented by the web browsing system according to the present invention;

FIGS. 11 to 14 are views showing embodiments of the present invention;

FIG. 15 is a view showing the shape of a tenth output window implemented by the web browsing system according to the present invention; and

FIG. 16 is a view showing the shape of an eleventh output window implemented by the web browsing system according to the present invention.

### BEST MODE

Hereinafter, the present invention will be described in detail with reference to the attached drawings.

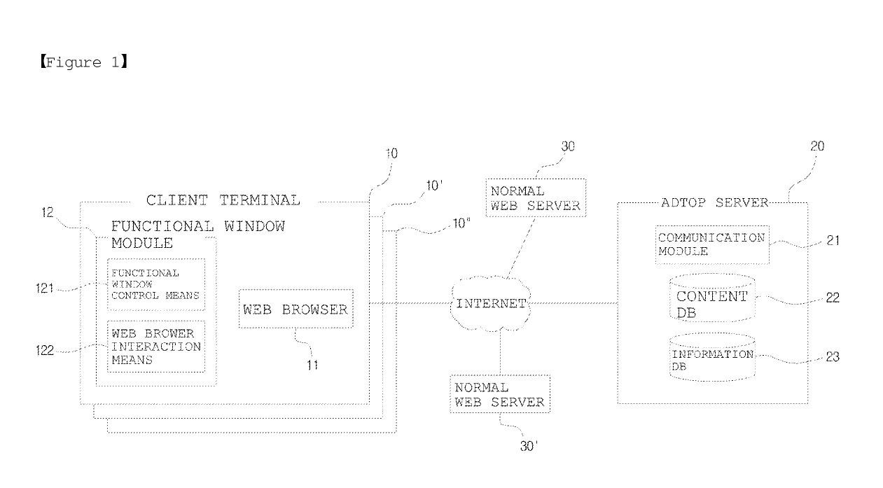

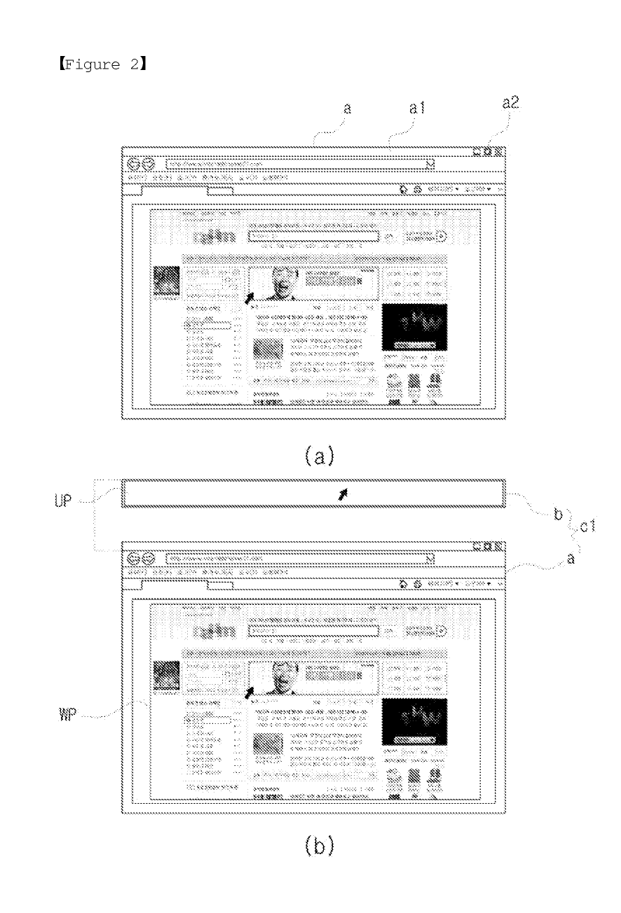

FIG. 1 is a block diagram showing the construction of a web browsing system according to the present invention, and FIG. 2 is a diagram showing the shapes of an existing output window and a first output window implemented by the web browsing system according to the present invention. A description will be made with reference to the drawings.

The web browsing system of the present invention includes client terminals 10, 10′, and 10″ (hereinafter referred to as ‘10’), each provided with a functional window module 12 installed therein, and an Adtop server 20 for providing information and controlling the functional window modules 12 while communicating with the functional window modules 12. In this case, the functional window modules 12 communicate with the Adtop server 20 via the web browsers 11 of the respective client terminals 10.

Each functional window module 12 is configured as an Adtop program provided by the Adtop server 20 is installed in a corresponding client terminal 10, and may have an independent application structure which interacts with the existing web browser 11, or have an application structure which is installed in the existing web browser 11 in such a way as to update the web browser 11.

The functional window module 12 installed in the client terminal 10 includes a functional window control means 121 and a web browser interaction means 122. As described above, since the functional window module 12 communicates with the Adtop server 20 over the Internet via the web browser 11, the web browser interaction means 122 for interacting with the web browser 11 is required.

The functional window control means 121 activates and displays a functional window b which interacts with an existing output window a that is displayed by the web browser 11 at the time of accessing the Internet, and completes a first output window c1 composed of the existing output window a and the functional window b.

As shown in FIG. 2(b), since the functional window b, together with the existing output window a, form the single first output window c1, the existing output window a and the functional window b can pop up and down together. In the case of adjusting the size of a window, the size of the functional window can be adjusted while the size of the existing output window a is adjusted. However, since the existing output window a and the functional window b are windows that are actually implemented as independent frames a1 (the functional window is a layered window), buttons a2 are independently formed on respective frames a1 constituting the output window a and the functional window b, and the existing output window a and the functional window b can be configured to be separately operated by the manipulation of the buttons a2.

Meanwhile, the functional window b can sense and control operations caused by an event occurring on a web page (WP) displayed on the existing output window a by means of event sink with the web page (WP).

The functional window b is a kind of window formed adjacent to the existing output window a displayed when the web browser is running, and basically overrides output window objects of the web browser, thus holding the same parent output window as the web browser which loaded the web page (WP). That is, the web browser and the functional window b can implement both their independent functions and interactive functions while sharing the event sink and the output window objects with each other.

The functional window b is basically separated from the web page window with respect to a boundary defined by a menu bar and an address bar configured in the existing output window a, and is separately executed independently of the web page window, as described above.

In this case, the boundary between the functional window b and the web page window is not always formed by the menu bar, the address bar, etc., and can be variously modified and implemented without departing from the scope of the accompanying claims. For reference, the web page window and the functional window can be separated around a frame delimiting the existing output window a while being arranged on left and right sides rather than upper and lower sides. Alternatively, the sequence of the vertical arrangement of the web page window and the functional window b can be changed, unlike the above embodiment shown in the drawing.

The Adtop server 20 includes a communication module 21 for controlling the client terminal 10 while communicating with the client terminal 10 over the Internet, and a content DB 22 and an information DB 23 for storing data that is transmitted or received via the communication module 21.

The content DB 22 transmits or provides relevant content information to the client terminal 10 either periodically or at the user's request under the control of the communication module 21 while storing advertisements, life information, and other various types of content information.

The information DB 23 stores and manages information about users. Here, the user information may be personal information such as the name, address and resident registration number of each user. In the web browsing system of the present invention, when the Adtop server 20 performs a service for transmitting and providing advertisements to the client terminal 10, information about the advertisers of relevant advertisements will also be stored in the information DB 23 as personal information.

The communication module 21 controls the input and output of data to and from the content DB 22 and the information DB 23, and controls the status of communication between the client terminal 10 and the Adtop server 20, and may also control the operation of the functional window b that is being displayed on the client terminal 10 as occasion demands.

In this case, the client terminal 10 and the Adtop server 20 are shown as performing communication over the Internet which is a public communication network that mediates communication between various normal web servers 30 and 30′, but it is apparent that the web browsing system according to the present invention can be applied even to an isolated communication network implemented as a Local Area Network (LAN) which is a personal area network.

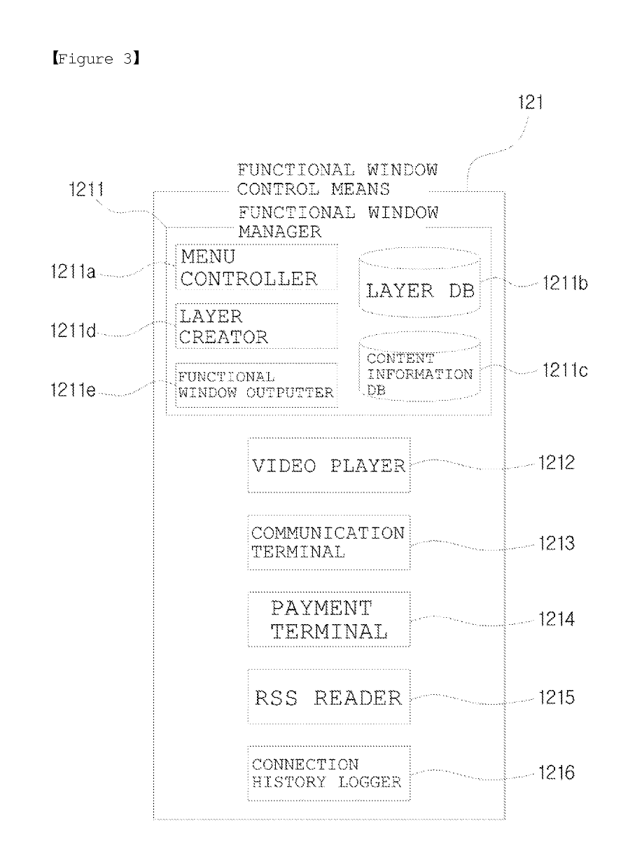

FIG. 3 is a block diagram showing the construction of the functional window control means according to the present invention. A description will be made with reference to the drawing.

The functional window control means 121 according to the present invention includes a functional window manager 1211, which includes a layer DB 1211b, a content information DB 1211c, a menu controller 1211a, a layer creator 1211d, and a functional window outputter 1211e.

The functional window control means 121 allows the user to use various types of content displayed on the functional window b via the web browser interaction means 122 using the same method as a conventional Internet usage method while performing control and management so that the functional window b is displayed together with the existing output window a on the client terminal 10. The functional window manager 1211 collectively performs interaction with the existing output window a, the display of various types of content, communication with the Adtop server 20, etc.

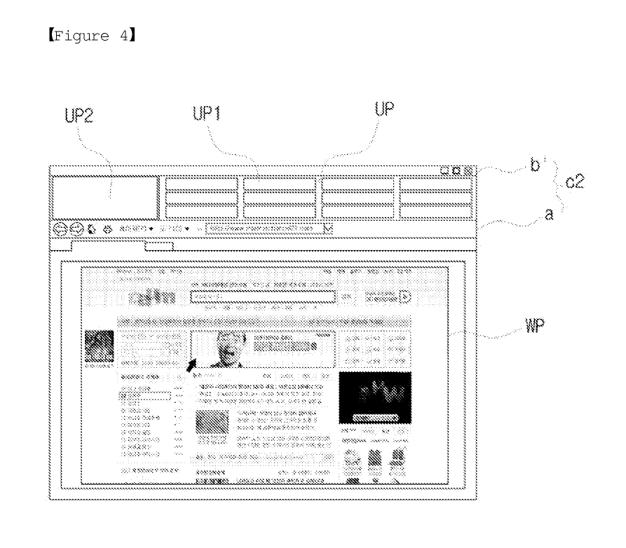

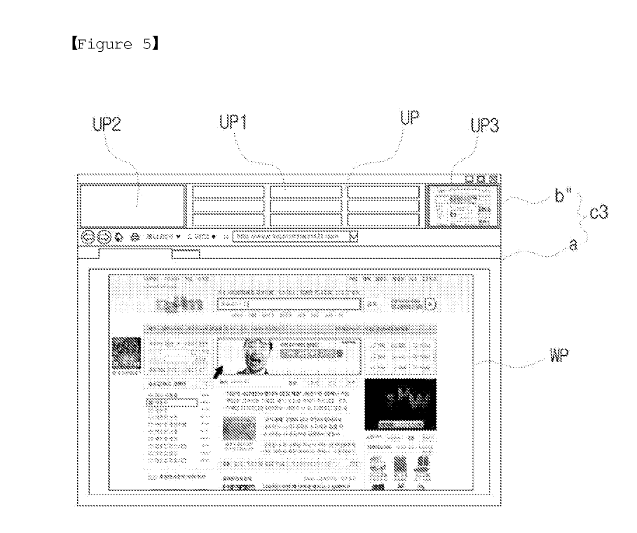

As described above, the layer DB 1211b stores layer information about various types of functional windows b, b′, and b″ (hereinafter referred to as ‘b’) required to display content, as shown in FIGS. 4 and 5 (showing the shapes of second and third output windows implemented by the web browsing system according to the present invention) while enabling the functional window b to be operated together with the existing output window a.

The content information DB 1211c stores information about content posted on the functional window b, and may include various types of information linked to relevant content that is currently posted, as well as the data of the relevant content. The functional window b is a kind of web browser, and enables the display of all types of information that can be represented by the web browser. Therefore, the information stored in the content information DB 1211c may be in a document format (HTML, XML, TXT, EXCEL, HWP, PDF, or the like), an image format (BMP, DIE, JPG, GIF, PNG, TIF, TIFF, or the like), and a video format (AVI, MOV, SWF, MPG, WMV, ASF, RA, RAM, DIVX, VOB, or the like). In addition, any type of information can be stored as long as it is in a format that can be represented by an existing web browser.

The menu controller 1211a receives layer information and content information from the layer DB 1211b and the content information DB 1211c, respectively, and manages the operations of the functional window b while interacting with output windows c1 to c5 (hereinafter referred to as ‘c’). The operation of the menu controller 1211a will be described in detail using an example.

The layer creator 1211d checks the sizes of the existing output window a, a relevant menu bar, and a relevant address bar so as to display the functional window b, and creates a layered functional window b having a size sufficient to hide the menu bar or the address bar, thus enabling the functional window b to be viewed as a single output window c instead of the menu bar or the address bar of the existing output window a.

Meanwhile, the size of the layered functional window b may be implemented to hide the entirety of the existing output window a. In this case, the menu bar or the address bar of the existing output window a is covered with the functional window b including various types of edited functional pages UP, and the web page window is hidden by a transparent layer, thus allowing the user to view the web page (WP) of the web page window. In this case, the layer creator 1211d checks the current web page (WP) that is being displayed on the web page window, detects the location of an empty space or an existing advertising space, and then inserts new information (including an advertisement) into the corresponding location of the transparent layer hiding the web page window to replace the empty space or the existing advertising space.

The functional window outputter 1211e is configured to adjust and manage the display method and format of the functional window b, and performs functions such as the function of displaying a functional window using a widget box and the function of adjusting the size of the functional window b and displaying the size-adjusted functional window. That is, the functional window outputter 1211e searches the layer DB 1211b for the information of the functional page UP displayed on the functional window b and displays the found information.

### A. FIRST EMBODIMENT

As shown in a second output window c2 (refer to FIG. 4), a functional page UP is displayed on a functional window b′ displayed under the control of the layer creator 1211d as if a web page (WP) were displayed on an existing output window a. The functional window outputter 1211e searches the layer DB 1211b for the shape of the functional window b′ and then displays the functional window b′, and the functional page UP is displayed in conformity with the format of the functional window b′.

Meanwhile, the functional page UP displayed on the functional window b′ may include one or more menus UP1.

The menus UP1 may be used for various purposes depending on the information thereof. For example, the purposes include (1) advertising, (2) the provision of information, (3) bookmarking, (4) scrapping, etc.

In this case, elements (1) to (4) posted in the menus UP1 may be provided by the menu controller 1211a searching the content information DB 1211c, or may be posted without change after being directly received from the Adtop server 20.

(1) Advertising is intended to post an advertisement transmitted from the Adtop server 20 on each menu UP1, and allows the user to always view text, images or videos (including flash videos) posted on the menu UP1 while surfing the web using the existing output window a.

Meanwhile, an advertisement posted on the menu UP1 may be transmitted en bloc to the client terminals 10, 10′, and 10″ of an unspecified number of users, but advertisements for respective users may be searched for in and selected from the content DB 22 on the basis of user information registered in the information DB 23 of the Adtop server 20 and may be transmitted in a customized manner.

Next, customized advertisements may be provided by the following methods.

The functional window b′ is a web browser application (web control hosting application), and is capable of transmitting the Uniform Resource Locator (URL) path and cookie data of a web page that is accessed to the Adtop server 20.

The Adtop server 20 that received the URL path and cookie data of the web page transmitted in this way inputs the URL path and the cookie data to a cookie analysis server (not shown) and a URL statistics server (not shown), analyzes the URL path and the cookie data for individual items such as the age, purchasing patterns, and interests, and transmits related advertising content from the content DB 22 to corresponding users.

An advertisement posted on the menu UP1 may be content implemented using only text, an image or a video so that the user simply views the contents of the advertisement, but may include link information so that when the user clicks the relevant menu UP1, a web page (WP) linked to the menu is displayed on the existing output window a of the second output window c2 or the web page window of a new pop-up output window.

(2) The provision of information is intended to post typical cultural or knowledge information items other than advertisements on the menu UP1, and is performed in the same manner as that of the above-described advertisement posting, except that only the genre of information is different from that of advertisements.

(3) Bookmarking is implemented by applying an existing ‘bookmarking’ method to register a web page (WP) viewed by the user during web surfing. ‘Bookmarking’ in the web browsing system according to the present invention enables the saving or loading of a bookmark to be performed at a time by merely clicking the menu UP1 in such a way as to abbreviate the complicated conventional operation of clicking the menu ‘bookmarking’ and of executing the saving or loading of a bookmark so as to perform ‘bookmarking’ on Internet Explorer.

In greater detail, as shown in FIG. 4, a functional page UP includes one or more menus UP1. In the case where the user has an interest in a current web page (WP) that is being displayed on the existing output window a, if the user selects (clicks) a relevant menu UP1, the web page (WP) is linked to the menu UP1 and is then saved therein. Consequently, when there is a need to save a web page (WP), which is being displayed on the existing output window a, as a bookmark, the web page (WP) is registered in the menu UP1 if the menu UP1 is clicked.

Meanwhile, when the relevant web page (WP) is registered in the menu UP1, the URL of the web page (WP) may be posted on the menu UP1, or a saved name of the web page may be posted while a separate input window pops up to enter the saved name of the web page, or an image or an icon of the web page (WP) may be posted.

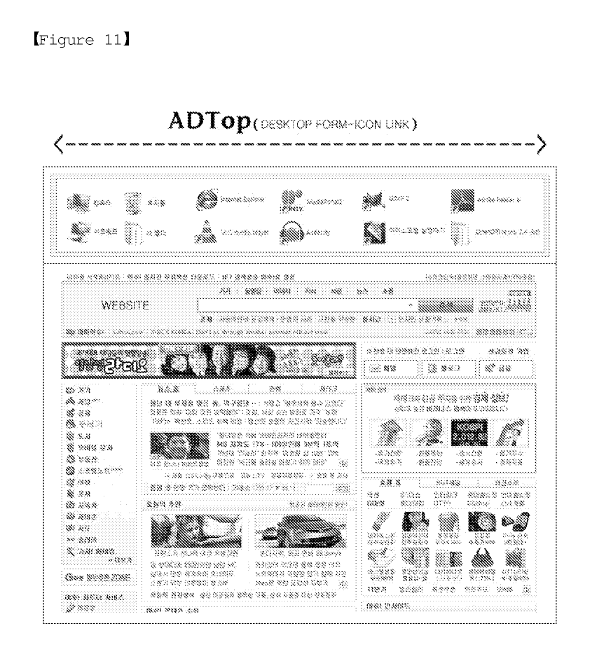

FIG. 11 is a view showing an embodiment of the present invention, which shows a shape in which (shortcut) icons on a desktop are posted on a menu (not denoted). That is, the functional window (not denoted) of the present invention enables icons of the desktop, as well as bookmarks, to be posted.

(4) Scrapping is intended to separately store only specific contents from a web page (WP) which includes various types of contents, and text or images (including videos) registered on the web page (WP) may be the target of scrapping.

Generally, a web page (WP) is composed of various types of text and images, which include the user's desired information and undesired information. Therefore, the user needs to separately scrap and manage only his or her desired information among various types of information. The web browsing system of the present invention scraps text or images constituting the web page (WP) to the menu UP1, thus allowing the user to easily utilize only the scrapped information.

A procedure for scrapping only the user's desired information from pieces of information, configured in the web page (WP), to the menu UP1 can be implemented using various methods. Of these methods, one method that can be easily used is a drag and drop method. In the case of text or a simple image, information included in the web page (WP) can be registered in the menu UP1 using functions such as ‘copy’ and ‘paste’.

The information scrapped in this way can be executed using various methods. For example, when scrapped information is text, if the user moves a mouse cursor close to the relevant menu UP1 or clicks the menu UP1, a layer on which the text is registered is displayed, and thus the scrapped text can be displayed so that the user can view the scrapped text. In another example, in the case where the scrapped information is an image (including a video) or a sound source, if the user clicks the relevant menu UP1, a video player 1212 is executed, and thus the scrapped image or sound source can be output so that the user can view or listen to the image or the sound source.

Next, as shown in FIGS. 4 and 5, the menu UP1 can be represented in a form in which a plurality of menus UP1 are arranged on a single layer, or can be implemented as a layered structure of a plurality of layers divided into an upper list and a lower list. Typically, such a tree-shaped layered structure (an upper list-lower list structure) is also called a drop down menu configuration, and coincides with the concept of Windows^{R} folders (Windows^{R} is an operating system (OS)).

That is, the user can efficiently manage his or her information while classifying menus UP1 into genres and configuring lower menus in each of the classified menus.

### B. SECOND EMBODIMENT

The functional window b′ may further include a first functional area UP2. The first functional area UP2 indicates a tool in which an image (a video) or a sound source can be played. Such a tool can be executed while occupying a separate space in the functional window b′, and the existence or arrangement location thereof may be flexibly adjusted depending on the contents of the functional page UP.

Meanwhile, the execution file of the first functional area UP2 may be an image (a video) or a sound source stored in each menu UP1, or may be an image (a video) or a sound source stored in another folder (directory) in the client terminal 10. Further, the first functional area UP2 required to play the image (video) or the sound source may be configured such that it is not displayed when being deactivated, and is displayed only when the image (video) or the sound source is played.

Therefore, the user may play the image (video) or the sound source without closing or popping down the second output window c2 even while surfing the web using the second output window c2, and may also play an image (a video) or a sound source registered in the menu UP1.

Next, for the purpose of independently activating the first functional area UP2, the functional window control means 121 may further include a video player 1212. The video player 1212 is a tool capable of playing even sound source files as well as images (videos) and typical images. When the user manipulates the video player to play images (videos) or sound sources, a menu controller runs the video player 1212, thus outputting images (videos) or sound sources desired to be manipulated.

### C; THIRD EMBODIMENT

The first functional area UP2 may be a tool which mediates Internet communications such as chatting, messenger, Short Message Service (SMS), and an Internet call (including a video call). For this operation, the functional window control means 121 may further include a communication terminal 1213 for controlling the tool.

The communication terminal 1213 may be a chatting program, a messenger program, an SMS program, or an Internet call program which is well known, and is configured such that when the user runs such a program, he or she can communicate with the other party while the communication terminal 1213 is driven.

For this, the communication terminal 1213 sends or receives related information while communicating with the communication module 21 of the Adtop server 20, and the communication module 21 sends or receives the related information to or from a user, who is a communications target, over the Internet.

### D; FOURTH EMBODIMENT

The first functional area UP2 may be a payment tool for electronic commerce (e-commerce). As described above, since the menu UP1 can temporarily store (by bookmarking or scrapping) various types of information present in a web page (WP), information about commodities desired to be purchased may be included in the information temporarily stored in this way. Thereafter, the user may select a specific one from among pieces of information about commodities that are desired to be purchased and are then collected, and may pay for the specific commodity. In this case, electronic commerce can be completed using the payment tool configured in the first functional area UP2.

For this, the functional window control means 121 may further include a payment terminal 1214.

Generally, when e-commerce is performed, it is completed using a separate payment tool in each e-commerce website. However, when the server of a trade website which conducts e-commerce is connected to the Adtop server constituting the system of the present invention for business and technical purposes (Internet communication technology), a payment procedure may be performed in an integrated manner for e-commerce related to commodity information acquired from the relevant trade website by using the payment terminal 1214 regardless of the type of trade website. That is, at the present time, a payment system is implemented based on contracts with individual companies, but may also be operated as an integrated payment system for each client in the form of a user's own payment system.

### E; FIFTH EMBODIMENT

The first functional area UP2 enables information, which can be provided using an RDF Site Summary (RSS) method by various websites, as well as by the press websites such as newspaper websites and broadcasting station websites, to be received/output. Consequently, the information can be received and utilized without a separate output window popping up to read information transmitted using the RSS method. By means of this function, the efficiency of the acquisition of Internet information by the user can be improved, and concentrating on all the information provided by the second output window C2 can be improved.

Meanwhile, in order to provide information in the RSS manner via the first functional area UP2, the functional window control means 121 further includes an RSS reader 1215.

The RSS reader 1215 feeds RSS content selected from websites which provide promised RSS in real time and tags the RSS content in Extensible Markup Language (XML), and then displays resulting content in the first functional area UP2.

### F; SIXTH EMBODIMENT

The first functional area UP2 may be a tool for checking the history of the Internet access. For this, the functional window control means 121 further includes a connection history logger 1216.

Generally, a web browser collects cookies from normal web servers 30 and 30′ connected thereto. A protector can check the contents of a website accessed by the user while the connection history logger 1216 separately manages the cookies collected in this way. For this function, the first functional area UP2 is a location where the protector accesses, and outputs and provides cookie information. In order to access the location, a separate login procedure may be performed. That is, when the first functional area UP2 is clicked, an Identification (ID)/password (PW) input window or layer for login is displayed. When the correct ID/PW are entered, cookie information is displayed in the first functional area UP2.

Information registered in the first functional area UP2 may be represented in the format of a URL, but is not limited to this format, and it is also possible to cause a web page image of the URL to be viewed. The latter embodiment will be described again in detail later with reference to a seventh embodiment.

### G; SEVENTH EMBODIMENT

As shown in FIG. 5, the functional window b″ of the third output window c3 may further include a second functional area UP3. The second functional area UP3 displays a web page, and is configured such that when the user clicks a menu UP1 that stores information about a specific web page such as a bookmark, or moves a mouse cursor to the menu UP1, an image of the web page linked to the relevant menu UP1 is displayed. That is, when the user clicks the menu UP1, the occurrence of a situation in which a new output window pops up and then the screen becomes complicated can be minimized. Accordingly, the user can stably surf the web in a simpler and arranged environment.

Further, the cookie information described in the sixth embodiment is traced, so that an image of a web page related to the cookie information can be displayed in the second functional area UP3.

The second functional area UP3 may display a user's home page or blog implemented in HTML format, in addition to a web page image which is a simple image. That is, two or more web page windows in which a web page (WP) can be displayed are formed in one third output window c3.

The functional window b″ is also a web browser application (a web control hosting application) and can be implemented in HTML, and thus HTML data of various types of homepages or blogs can be loaded into the functional window b″ and can be processed.

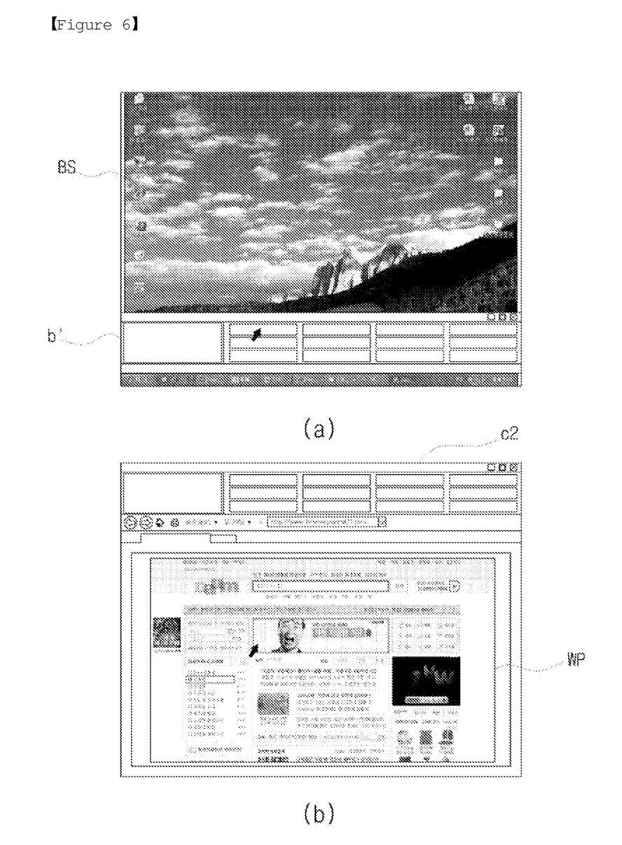

FIG. 6 is a view showing the operation of the web browsing system according to the present invention, and a description will be made with reference to the drawing.

The functional window b′ may be displayed while the web browser is running, but may be displayed separately from the web browser, as shown in FIG. 6(a). That is, the user can take various types of information without displaying a web page via the web browser while executing various types of content, registered in the menu UP1, in the first functional area UP2 (or the second functional area).

Meanwhile, when a menu UP1 saved as the target of bookmarking is selected or an icon of Internet Explorer (IE) is selected, and then an Internet access program is executed, the functional window b′ together with the existing output window a can constitute a second output window c2, as shown in FIG. 6(b).

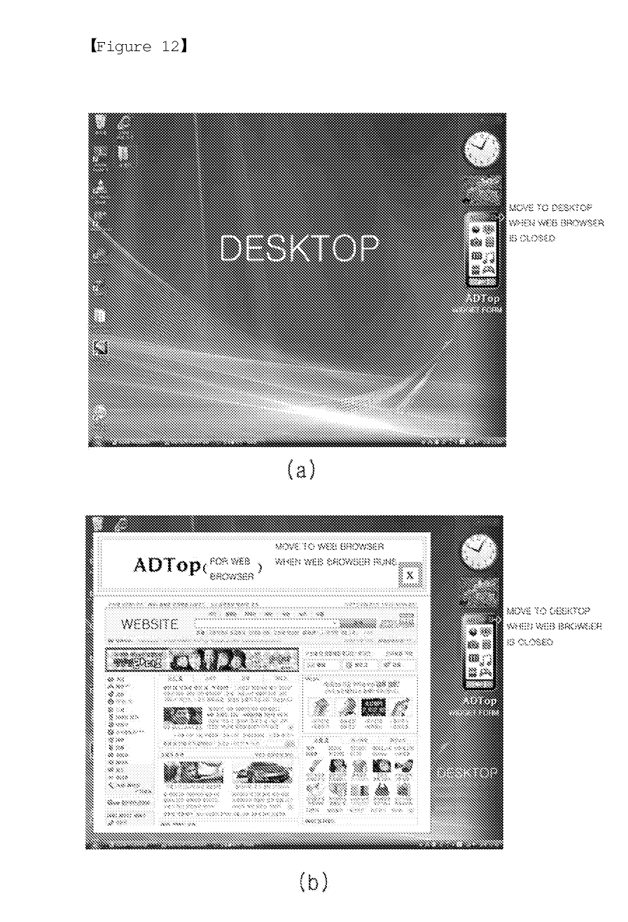

FIG. 12 is a view showing an embodiment of the present invention, wherein the shape of the functional window b′ separately displayed on a desktop, as described above, may be displayed in the form of a widget box having a peculiar shape different from that of the functional window b′ included in the second output window c2.

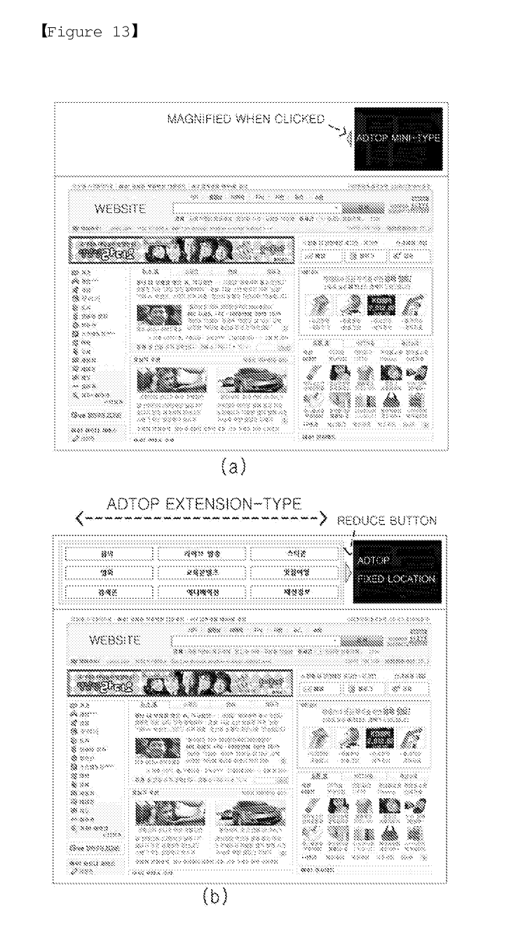

That is, as shown in FIG. 12(a), the functional window outputter 1211e displays a widget box (or a specific icon) on the desktop, and allows a second output window c2 (not denoted in FIG. 13) including a functional window b′ (not denoted in FIG. 13) to be displayed, as shown in FIG. 12(b) when the user clicks the widget box.

Consequently, as shown in FIG. 6(a), a functional window b′ displayed alone on the desktop may be the same image as that displayed on the functional window b′ included in the second output window c2, but when a widget box which is a functional window of another image is displayed on the desktop, as shown in FIG. 12, and is clicked, the second output window c2 may be displayed.

The size of the functional window b may be adjusted independently of the existing output window a by using a button provided on a frame or a menu (not shown) provided on the functional page UP under the control of the functional window outputter 1211e, as described above.

However, it is possible to adjust the format of the functional window b rather than merely adjusting the size.

This procedure will be described in detail below. The functional window b displayed at its full size, corresponding to the existing output window a, may be modified into a specific icon, or may be modified so that only a part of the functional window b is displayed, by clicking the button. Of course, when the button is clicked again, the functional window b may be displayed back at its full size to allow the user to utilize the functional window b.

FIG. 13 is a view showing an embodiment of the present invention, which shows the adjustment of the size of the functional page displayed on a functional window b. FIG. 13(a) shows that part or all of the functional page of the functional window is reduced and modified into a specific icon or button, and FIG. 13(b) shows that the functional page is turned back into its original shape when the icon is clicked.

The functional window outputter 1211e causes the entire functional page to be displayed or disappear by the user manipulating the icon or button, as shown in FIG. 13, while controlling whether to display a functional page that is displayed on the functional window.

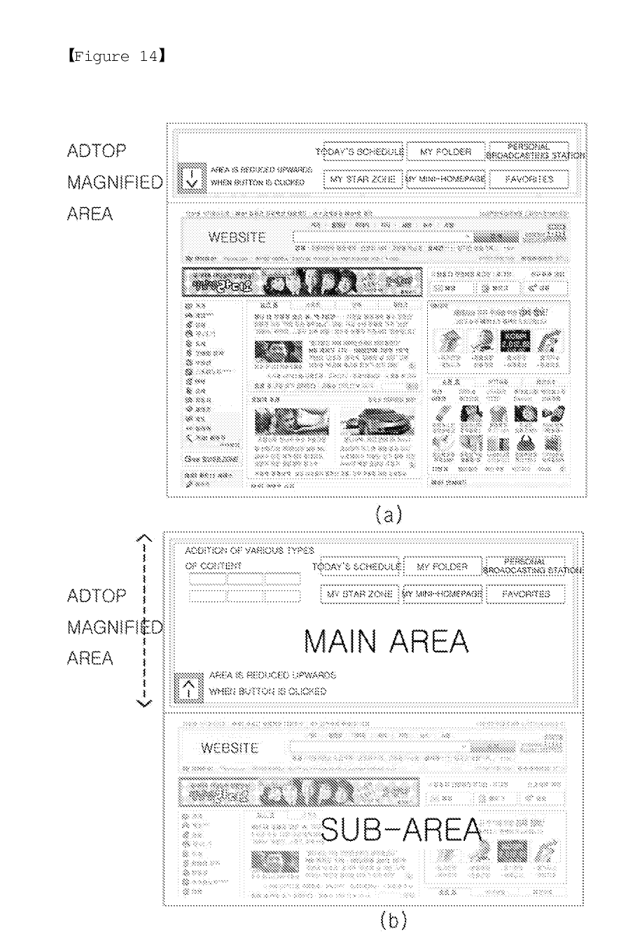

FIG. 14 is a view showing an embodiment of the present invention, which shows that the size of a functional window b can be adjusted. That is, as shown in FIG. 14(a), the functional window outputter 1211e maintains the normal size of the functional window, and when the button is clicked, increases the size of the functional window by extending the functional window, as shown in FIG. 14(b). Of course, the functional window outputter 1211e turns the extended functional window back into its original size when the button is clicked.

As described above, the embodiments described with reference to FIGS. 13 and 14 are implemented in such a way that the functional window outputter 1211e searches the layer DB 1211b for format information related to the functional page UP, and executes the format information.

A character (not shown) interacting with the functional window b is displayed on the desktop (BS) of the client terminal 10 independently of the first to third output windows c1, c2, and c3, and the character displayed in this way replaces the function of the functional window b. Further, the function may be operated to be limited to a specific website.

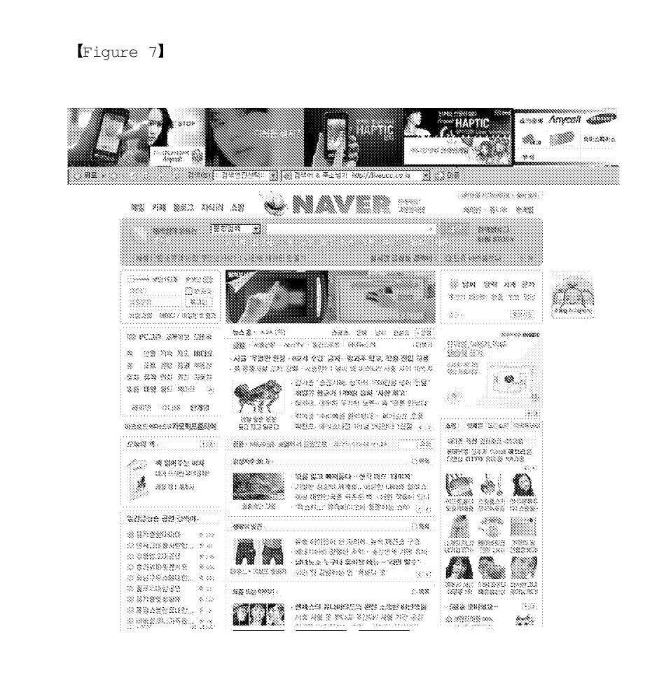

FIGS. 7 to 10 are views showing the shapes of sixth to ninth output windows implemented by the web browsing system according to the present invention. The shapes of the functional windows implemented by the web browsing system of the present invention are exemplified.

The functional page UP displayed on the functional window b can be represented by various formats and images, as shown in FIGS. 7 to 9. In FIG. 7, an advertising function is provided, wherein when a user clicks a functional page UP, the website of an advertiser of a relevant advertisement may pop up as a separate output window, or, alternatively, an advertising video may be played on the web page window of the output window. Further, the relevant advertising video may be played on the functional page itself. In this case, when the advertising video is played on the web page window, the contents and configuration of the functional page may be maintained in the same state as that of FIG. 7.

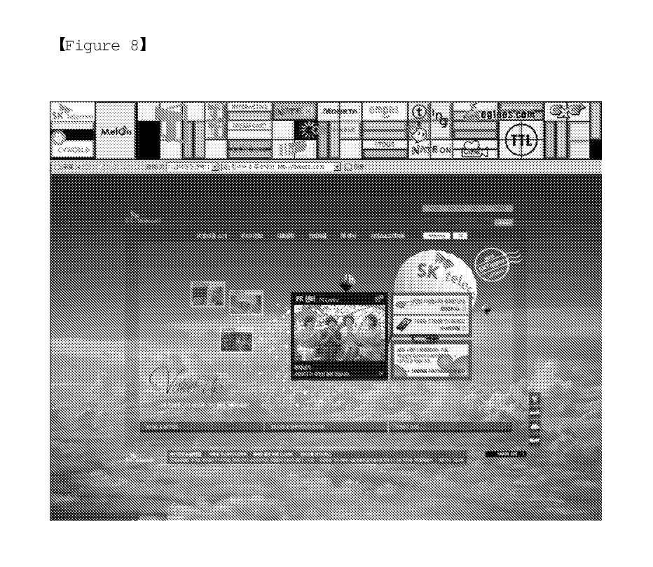

Meanwhile, as shown in FIG. 8, various menus UP1 may be displayed on the functional page UP, so that a web page linked to each menu UP1 may be displayed by clicking the menu UP1 rather than by clicking the entire functional page.

That is, when the user selects one from among various menus provided on the functional page UP, a web page linked to the relevant menu may be displayed on the web page window, or the linked web page may be displayed while a separate output window pops up, or the web page or a registered page may be displayed on the functional window b.

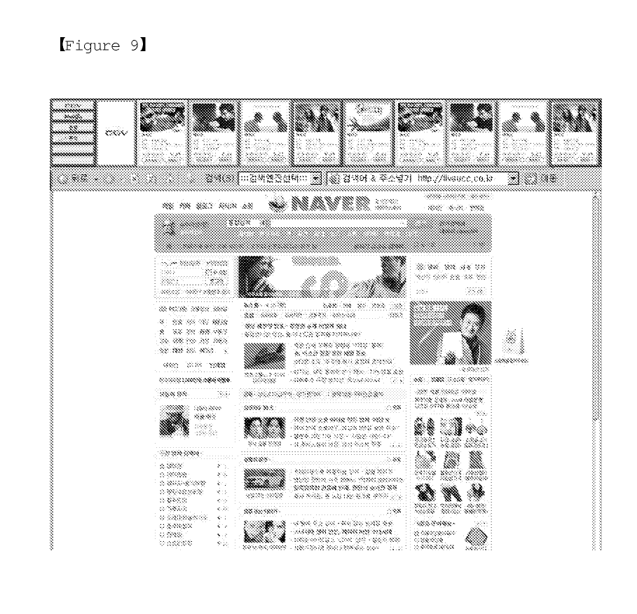

In FIG. 9 which shows another embodiment of the display of various menus UP1 on one functional page UP, a menu selection structure is formed as a layered structure (a structure of an upper list and a lower list), thus enabling the functional page UP to be executed as if the menus pages were pages (layers) linked to one another.

In greater detail, an upper list is disposed on the left side of the functional page UP, and lower lists belonging to each menu of the upper list are arranged on the right side, thus allowing the user to effectively view and read various types of information. In other words, when the user clicks ‘CGV’ which is a representative brand of movie theater industry in the upper list on the left side, a relevant lower list is displayed on the right side without the upper list changing, so that the user can view menus in the lower list, click his or her desired information, and be then provided with more detailed information.

Of course, when the user clicks a menu in the lower list, a web page linked to the relevant menu may be displayed on a separate output window, or the web page may be displayed on the web page window, or the web page or a promised page may be displayed on the functional window.

Meanwhile, when the user clicks another upper list, the contents of the lower list are changed to information related to the newly selected upper list, and are provided to the user.

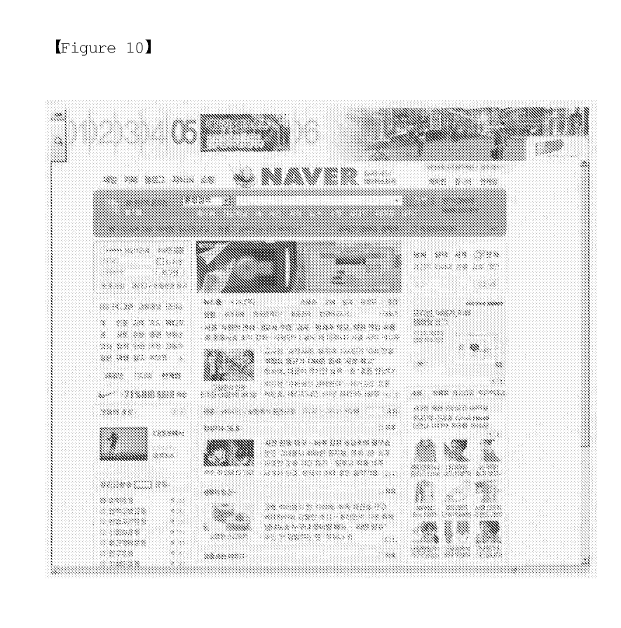

FIG. 10 is a view showing the shape of a ninth output window implemented by the web browsing system according to the present invention. A description will be described with reference to the drawing.

The display state of a functional window b can be determined using selection keys located on an upper left portion. Here, as the selection keys, a key having the shape of a ‘tack’ and a key having the shape of a ‘magnifier’ are illustrated, wherein the ‘tack’-shaped key allows the functional window b to always be displayed. That is, when the user moves a mouse cursor to the functional window b, the functional window b may disappear. In this case, it is possible that when the tack-shaped key is clicked, the functional window b may always be displayed or that when the mouse cursor moves to the functional window b, the functional window b may disappear.

Meanwhile, the ‘magnifier’-shaped key is linked to a web page related to the contents of the functional window b, so that when the key is clicked, the web page may pop up on a separate output window, or may be displayed on the web page window of the output window.

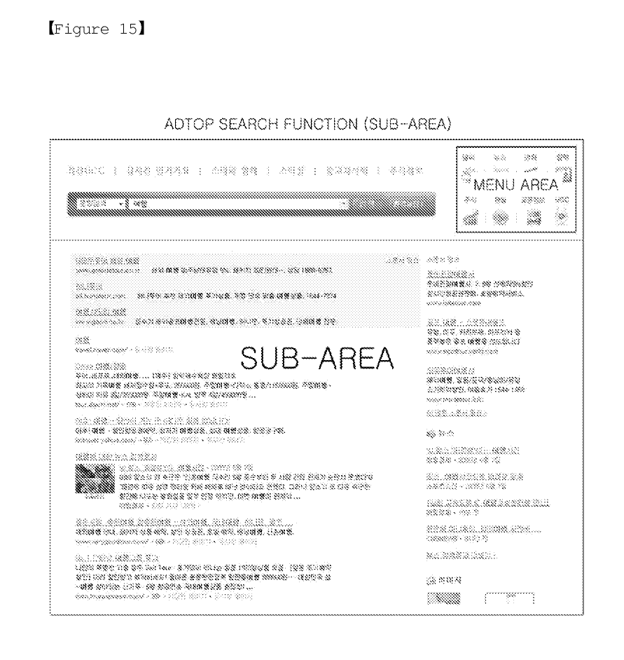

FIG. 15 is a view showing the shape of a tenth output window implemented by the web browsing system according to the present invention, and a description will be made with reference to the drawing.

A tenth output window is configured such that a search box is provided in a functional window and when a keyword is entered into the search box, the results of search are displayed on a web page window. This format may be implemented in an output window activated by an Internet access program, but may also be implemented on an Operating System (OS) level.

An embodiment of the latter case will be described with reference to the drawing.

When the user boots a client terminal, an OS displays a functional window which is a main area, and a web page window which is a sub-area, on a desktop while a typical booting operation is being performed. In this case, on the functional window, a menu area which includes a search box and menus is displayed. On the web page window, a blank or various types of guidance may be displayed.

Next, when the user performs a search operation by entering a keyword into the search box, the results of search are displayed on the web page window as if a typical portal website displayed search results. Thereafter, when the user selects and clicks any one from among the search results, a new window pops up, so that the user can be provided with detailed link information related to the selected search result.

Such a scheme may provide a very useful and convenient usage means according to the tendency to provide document editing SW or the like via an Application Service Provider (ASP) on the web without providing it as a licensed version.

Meanwhile, an embodiment of the former case is configured such that the tenth output window pops up as a typical web window, and this web window includes a functional window and a web page window. That is, the user executes an Internet access program or clicks a functional window or a widget box, as shown in FIG. 6 or 12, thus enabling the tenth output window to be consequently displayed.

The functional window of the tenth output window displayed in this way includes a search box. A menu controller 1211a transmits a keyword entered into the search box to a search website linked to the Adtop server 20 via the web browser 11, and the search website transmits the results of search matching the keyword to the client terminal 10, and then posts the results of search on a functional window, a web page window or a new output window.

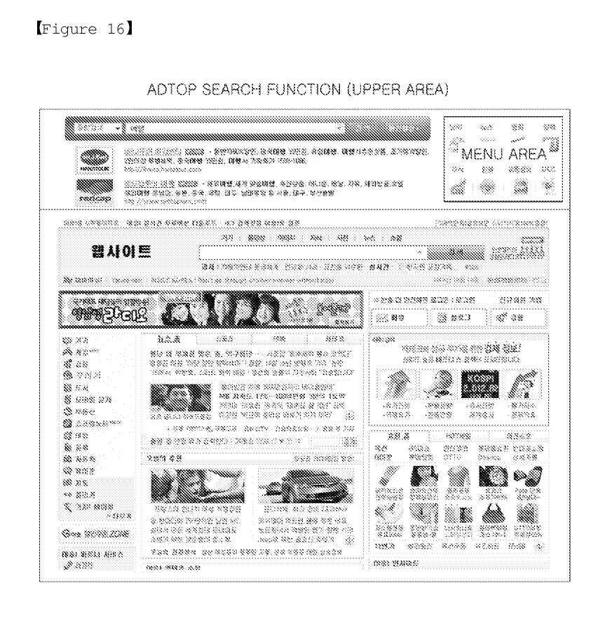

FIG. 16 is a diagram showing the shape of an eleventh output window implemented by the web browsing system according to the present invention, and a description will be made with reference to the drawing.

Similarly to the tenth output window, the eleventh output window is implemented such that a functional window includes a search box. When searching is performed by entering a keyword into the search box, the results of search matching the keyword are displayed on a functional window rather than a web page window. Of course, when one of the search results displayed on the functional window is selected, a web page linked thereto is displayed on the web page window, thus allowing the user to easily view the search result and also easily and conveniently view other search results.

The above-described web browsing system according to the present invention can be variously applied to any devices without being limited to typical client terminals, as long as the devices are capable of accessing a multi-communication system such as the Internet. Therefore, it is apparent that the present invention can also be applied to mobile devices enabling wireless Internet communication, or systems such as Internet Protocol Television (IPTV) enabling two-way communication

1. A web browsing system, comprising:
a web browser (11); and
a functional window module (12) including functional window control means (121) and web browser interaction means (122), wherein the functional window control means (121) includes a functional window manager (1211) having a content information database (DB) (1211c) for storing information about one or more selected from among text, images, video and sound sources, and content information linked to relevant information, a layer creator (1211d) for checking locations and sizes of a menu bar and an address bar in an existing output window (a) that includes a web page window, and activating one or more layered functional windows (b) so that the layered functional windows hide one or more selected from among the menu bar and the address bar and are displayed as a single output window (c) in appearance, the functional window (b) being configured such that a functional page (UP) for posting information is displayed, and a menu controller (1211a) for interacting with the web browser (11) to enable Internet communication based on information posted on the functional window (b); and wherein the web browser interaction means (122) mediates interaction between the menu controller (1211a) and the web browser (11), the web browsing system being installed in a client terminal.

2. The web browsing system according to claim 1, further comprising an Adtop server (20) comprising a communication module (21) for communicating with the functional window module (12), and a content DB (22) for storing information that is transmitted to the client terminal via the communication module (21) and is posted on the functional page (UP).

3. The web browsing system according to claim 1, wherein the functional window control means (121) further comprises a video player (1212) for outputting video information on the functional window (b).

4. The web browsing system according to claim 1, wherein the functional window control means (121) further comprises a communication terminal (1213) for performing communication, based on one or more selected from among email, a Short Message Service (SMS), and a messenger, on the functional window (b).

5. The web browsing system according to claim 1, wherein the functional window control means (121) further comprises a payment terminal (1214) for performing a payment operation related to electronic commerce or payment of public charges on the functional window (b).

6. The web browsing system according to claim 1, wherein the functional window control means (121) further comprises an RDF Site Summary (RSS) reader (1215) for displaying RSS information provided by various web servers on the functional window (b).

7. The web browsing system according to claim 1, wherein the functional window control means (121) further comprises a connection history logger (1216) for storing cookie information of a relevant web page displayed on the web page window, and displaying the stored cookie information on the functional window (b).

8. The web browsing system according to claim 1, wherein the menu controller (1211a) is configured such that the functional page (UP) has a plurality of menus (UP1), and performs processing such that pieces of information are posted for the respective menus (UP1).

9. The web browsing system according to claim 8, wherein the menu controller (1211a) structures the menus (UP1) in a format of an upper list and a lower list.

10. The web browsing system according to claim 8, wherein the menu controller (1211a) saves a web page (WP) displayed on the web page window with the web page linked to a relevant menu (UP1), and when the relevant menu (UP1) is selected, posts and displays the web page (WP) on the web page window or a new output window.

11. The web browsing system according to claim 8, wherein the menu controller (1211a) saves a web page (WP) displayed on the web page window with the web page linked to a relevant menu (UP1), and when the relevant menu (UP1) is selected, configures a second functional area (UP3) in which an image of the web page (WP) is displayed on the functional window (b).

12. The web browsing system according to claim 8, wherein the menu controller (1211a) selects information about text•images•videos•sound sources of a web page (WP) displayed on the web page window and content information related to relevant link information in a drag and drop manner, and posts the selected information on the menus (UP1).

13. The web browsing system according to claim 1, wherein the menu controller (1211a) displays all or part of the functional window (b), or any one selected from among icons of the functional window (b), on a desktop of a client terminal (10), and displays the output window (c) when all, part, or an icon of the functional window (b) that is displayed is selected.

14. The web browsing system according to claim 1, wherein the menu controller (1211a) partitions the functional window (b) of the output window (c) by a frame (a1) having independent buttons (a2) so that size adjustment, pop-up, pop-down, or closing of the functional window (b) is performed independently of the web page window.

15. The web browsing system according to claim 1, wherein the menu controller (1211a) displays a search box linked to a search website on the functional window (b), receives results of search matching a keyword entered into the search box from the search website, and posts and displays the results of search on the web page window or a new output window.

16. The web browsing system according to claim 1, wherein the functional window manager (1211) further comprises a functional window outputter (1211e) for adjusting a size of the functional page displayed on the functional window.

17. The web browsing system according to claim 1, wherein the functional window module (12) is executed when the client terminal is booted while interacting with an Operating System (OS) of the client terminal, the functional window control means (121) displays a functional window, including a search box linked to a search website, and the web page window on a desktop, and the menu controller (1211a) receives results of search matching a keyword entered into the search box from the search website, and posts and displays the results of search on the web page window or a new output window.
